(19) United States
(12) Patent Application Publication
(10) Pub. No.: US 2022/0180200 A1
(43) Pub. Date: Jun. 9, 2022

(54) UNSUPERVISED DOMAIN ADAPTATION USING JOINT LOSS AND MODEL PARAMETER SEARCH

(71) Applicant: International Business Machines Corporation, Armonk, NY (US)

(72) Inventors: Yi Qin Yu, Beijing (CN); Chao Xue, Beijing (CN); Shiwan Zhao, Beijing (CN)

(21) Appl. No.: 17/115,953

(22) Filed: Dec. 9, 2020

(51) Int. Cl. G06N 3/08; G06N 5/04; G06K 9/62

(52) U.S. Cl. CPC G06N 3/084; G06K 9/6256; G06N 5/046

(57) ABSTRACT

Aspects of the invention include methods and systems that include obtaining a source domain dataset. The source domain dataset includes corresponding labels, and the source domain dataset and the corresponding labels are associated with training a source domain machine learning model. A method includes obtaining a target domain dataset without corresponding labels and a feature vector that identifies features in the source domain dataset and the target domain dataset. The method also includes obtaining a set of loss terms from known machine learning models that implement a domain adversarial neural network (DANN) architecture. The DANN architecture includes feed-forward propagation and backpropagation. A target domain machine learning model is obtained based on the source domain dataset, the target domain dataset, the feature vector, and the set of loss terms and without labels for the target domain dataset to perform training.

### BACKGROUND

The present invention generally relates to programmable computers and, more specifically, to computer systems, computer-implemented methods, and computer program products configured to execute unsupervised domain adaptation techniques using joint loss and model parameter searching.

Machine learning traditionally involves training a machine learning model or algorithm to perform a task. In a training technique known as “supervised learning,” labeled datasets are used to train the model. The result of the training is a model in the domain defined by the dataset. When a labeled dataset is not available, but an unlabeled dataset of interest is related to another labeled dataset, domain adaptation may be used. Domain adaptation refers to leveraging the related labeled dataset (i.e., dataset in a source domain) and the unlabeled dataset (i.e., dataset in a target domain) to jointly learn an accurate model for the target domain. The source and target domains have the same feature space but different distributions.

### SUMMARY

Embodiments of the present invention are directed to unsupervised domain adaptation using joint loss and network search. A non-limiting example computer-implemented method includes obtaining a source domain dataset. The source domain dataset includes corresponding labels, and the source domain dataset and the corresponding labels are associated with training a source domain machine learning model. The method also includes obtaining a target domain dataset without corresponding labels, obtaining a feature vector that identifies features in the source domain dataset and the target domain dataset without an indication of domain, and obtaining a set of loss terms from known machine learning models that implement a domain adversarial neural network (DANN) architecture. The DANN architecture includes feed-forward propagation and backpropagation and a formulation of the DANN architecture includes a minimum portion and a maximum portion. A target domain machine learning model is obtained based on the source domain dataset, the target domain dataset, the feature vector, and the set of loss terms and without determining corresponding labels for the target domain dataset in order to perform training.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a process flow of a method of performing unsupervised domain adaptation using joint loss and model parameter search according to one or more embodiments;

FIG. 2 shows the domain adversarial neural network (DANN) architecture that is applied to performing unsupervised domain adaptation using joint loss and model parameter search according to one or more embodiments of the invention;

FIG. 3 shows two components of the full set of loss terms S determined according to one or more embodiments of the invention;

FIG. 4 is an exemplary algorithm used to determine the target model parameters according to exemplary embodiments of the invention; and

FIG. 5 is a block diagram of a processing system for implementing the unsupervised domain adaptation using joint loss and model parameter search according to one or more embodiments of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

As previously noted, domain adaptation facilitates the adaptation and application of a machine learning model trained in a source domain to a different but related target domain. An architecture to facilitate domain adaptation is a domain adversarial neural network (DANN). The DANN involves a feature extractor that extracts domain-invariant features, a label predictor that learns the discriminativeness among classes of the labeled data using a standard supervised training process, and a domain classifier that ensures that the learned representation is invariant across domains. The prior application of this DANN architecture has drawbacks. One exemplary issue is the use of a diverse set of loss terms without a determination of which is best for specific tasks.

Embodiments of the present invention are directed to systems and methods configured and arranged to perform unsupervised domain adaptation using joint loss and model parameter search. A full set of loss terms is generated. This full set may be reused for other domain adaptation tasks. The dataset of the source domain (i.e., the labeled dataset), a dataset of the target domain (i.e., the unlabeled dataset), and a feature vector obtained with the DANN architecture are used to jointly search the full set of loss terms and to search for model parameters for the target domain model. The result is a model in the target domain that is obtained without a labeled dataset in the target domain.

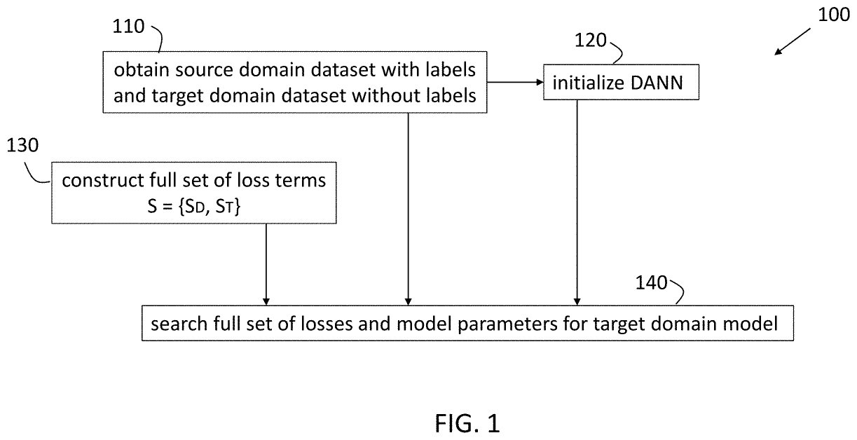

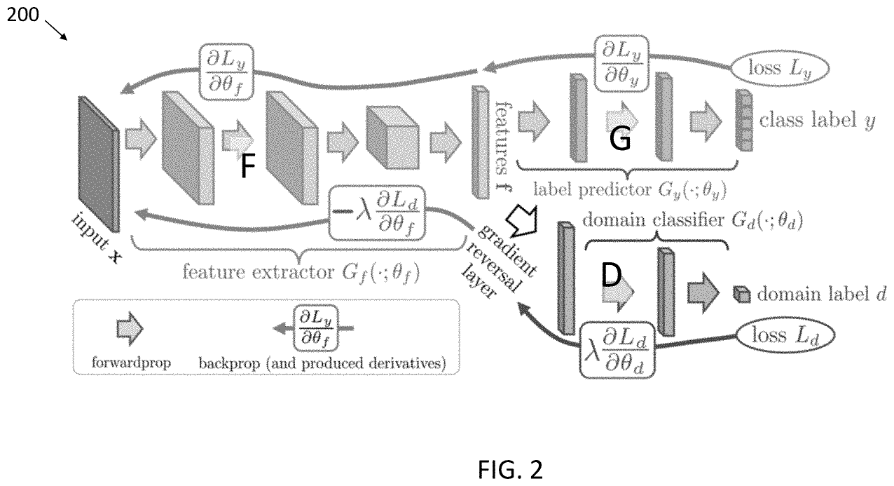

FIG. 1 is a process flow of a method 100 of performing unsupervised domain adaptation using joint loss and model parameter search according to one or more embodiments of the invention. At block 110, the processes include obtaining a source domain dataset with labels and a target domain dataset without labels. At block 120, initializing the DANN architecture 200 refers to using the source domain and target domain datasets to obtain feature vectors f from the feature extractor F of the DANN architecture 200 (FIG. 2). The DANN architecture 200 is illustrated and discussed with reference to FIG. 2. This DANN architecture 200 represents a basic model that becomes the target domain model based on parameters determined at block 140.

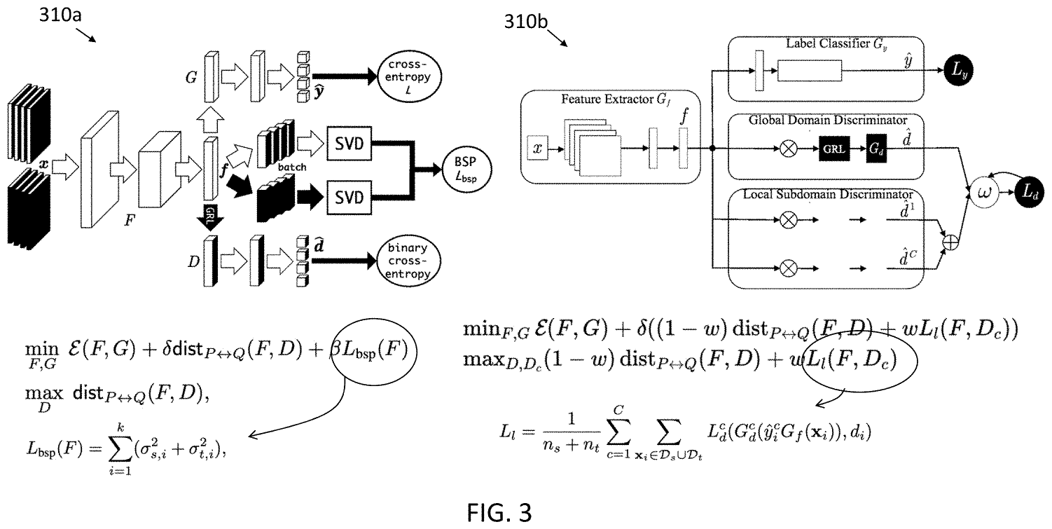

At block 130, constructing a full set of loss terms S={S_{D}, S_{T}} is an independent process, as shown, that may be performed and updated for use in a number of implementations of the domain adaptation according to one or more embodiments of the invention. The construction is detailed with reference to FIG. 3. At block 140, the full set of loss terms S (from block 130), the source domain and target domain datasets (from block 110), and the feature vectors f (from block 120) are all inputs. Specifically, a loss term is computed using the full set of loss terms S and the loss term is used to determine model parameters (ω, θ, α) for the target domain model. All the parameters are determined together according to the embodiments detailed herein. Ultimately, the target domain model is obtained, at block 140, without a labeled target domain dataset or training using a labeled dataset.

FIG. 2 shows the DANN architecture 200 that is applied to performing unsupervised domain adaptation using joint loss and model parameter search according to one or more embodiments of the invention. The DANN architecture 200 is well-known and only relevant aspects are discussed herein. A deep feature extractor (denoted as “F”) and a deep label predictor (denoted as “G”) form a standard feed-forward architecture. Based on both the labelled source-domain dataset and the unlabeled target-domain dataset, the feature extractor F output a feature vector f. The feature vector f is domain-invariant, meaning that features associated with the source domain are not distinguished from features associated with the target domain. A domain classifier (denoted as “D”) is connected to the feature extractor via a gradient reversal layer. The gradient reversal layer, which multiplies the gradient by a negative constant during backpropagation-based training, ensures that the feature distributions over the two domains are made as indistinguishable as possible to the domain classifier.

The adversarial domain adaptation is generally formulated as:

$$\begin{matrix}{}_{F , G}^{min} ɛ ( F , G ) + {δ dist}_{P ↔ Q} ( F , D ) & [ EQ . 1 ] \\ {}_{D}^{max}{dist}{}_{P ↔ Q}^{} ( F , D ) & [ EQ . 2 ]\end{matrix}$$

EQ. 1 pertains to the min portion and EQ. 2 pertains to the max portion, as referenced herein. P and Q are the respective distributions of the source and target domain samples. The first term in EQ. 1 relates to minimizing classification error ε (F, G) on the source labeled data. That is, the feature extractor F and the source classifier (i.e., label predictor G) are trained to make feature representations discriminative across categories. This is referred to as discriminability loss, and losses that optimize discriminability are part of S_{D}. The second term in EQ. 1 relates to minimizing a statistical distance dist_{p↔Q}(F, D) across the source and target distributions P and Q. That is, the feature extractor F is trained to confuse the domain classifier D to make feature representations transferable across domains (i.e., domain classifier D cannot distinguish samples as being from the source or target domain). This is referred to as transferability loss, and losses that optimize transferability are part of S_{T}. As discussed with reference to FIG. 3, the full set of loss terms S={S_{D}, S_{T}} obtained at block 130 includes discriminability losses S_{D} and transferability losses S_{T} from all known models at block 130.

FIG. 3 shows two components of the full set of loss terms S determined at block 130 of FIG. 2 according to one or more embodiments of the invention. Specifically, two known models 310a, 310b (generally referred to as 310) are shown that are based on the DANN architecture 200. The procedure discussed with reference to these two known models 310 is repeated for every known model 310 that is based on the DANN architecture 200. The models 310 may be collected from publications and other sources.

The model 310a includes a known batch spectral penalization (BSP) module that is plugged into a DANN network. The gradient reversal layer (GRL) is used in adversarial domain adaptation. The general formulations shown in EQS. 1 and 2 are modified as indicated below the model 310a. As indicated, L_{bsp}(F) is added as a loss term in the min portion. Thus, this loss term pertains to discriminability loss and is added to the set S as part of S_{D}. The model 310b is a DANN that includes a local subdomain discriminator, as shown. As indicated, L₁(F, Dc) is added as a loss term in the max portion. Thus, this loss term pertains to transferability loss and is added to the set S as part of S_{T}. Similarly, for other models 310 implementing the DANN architecture 200, any loss terms pertaining to the min portion are added to the set S as part of S_{D}, and any loss terms pertaining to the max portion are added to the set S as part of S_{T}. The set S={S_{D}, S_{T}} is constructed at block 130 in this manner using known models 310 that implement the DANN architecture 200.

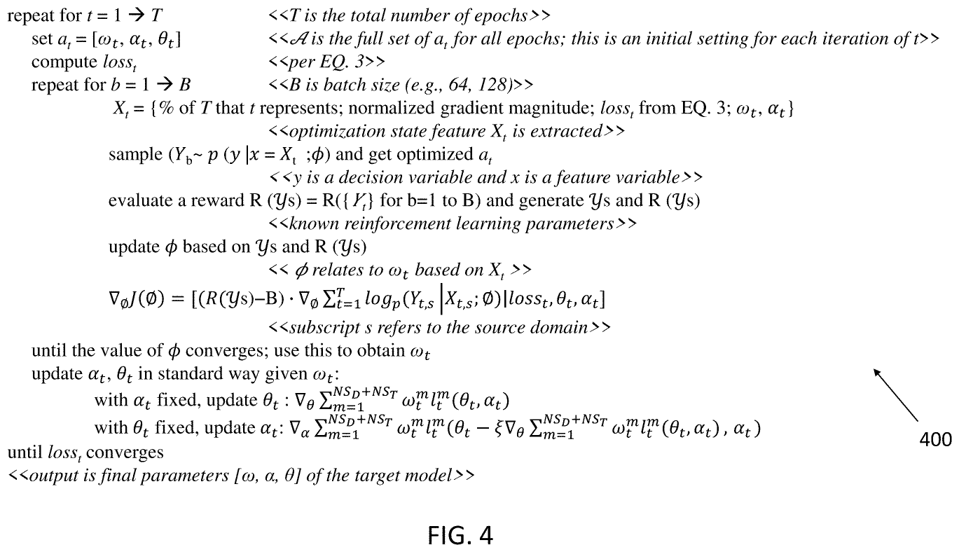

FIG. 4 is an exemplary algorithm 400 used to determine parameters (ω, θ, α) of the target model at block 140 according to exemplary embodiments of the invention. At block 140, the loss terms collected in the set S (at block 130) along with the datasets of the source domain and target domain (from block 110) and the feature vector f (from block 120) are used to determine multiple parameters of the target domain model. The following loss (lossₜ) is computed for each epoch t. The total number of epochs Tis a hyperparameter that is selected for the target domain model.

$${loss}_{t} = {\sum }_{{}_{F , G} i = 1}^{{min}_{{NS}_{D}}} {ω l}_{i} ( {G}_{{α}_{t} , {θ}_{t}} ( {F}_{{α}_{t} , {θ}_{t}} ( {x}_{s} ) ) , {y}_{s} ) + {\sum }_{j = 1}^{{NS}_{T}} {ω dist}_{j} P ↔ {QD}_{{α}_{t} , {θ}_{t}} ( {F}_{{α}_{t} , {θ}_{t}} ( {x}_{s} or {x}_{t} ) , d ) \qquad [ EQ . 3 ]$$

In EQ. 3, NS_{D} is the number of loss terms that are added to the set S (at block 130) as pertaining to the min portion and NS_{T} is the number of loss terms that are added to the set S (at block 130) as pertaining to the max portion. As previously noted, G, F, and D refer to the known functions of label prediction, feature extraction, and domain classification. Source samples from the source dataset and target samples from the target dataset are denoted xₛ and xₜ, respectively. Only the source samples xₛ have corresponding labels yₛ. The binary parameter d indicates whether the sample is a source sample xₛ or a target sample xₜ. The target domain model parameters co (i.e., weights of the customized losses in the set of loss terms S), a (i.e., weights of potential operations between two nodes in the feature extractor F), and 0 (i.e., weights of the feature network F) are determined together at block 140, as shown in the algorithm of FIG. 4.

FIG. 4 is an exemplary algorithm used to determine the target model parameters (ω, θ, α) at block 140 according to exemplary embodiments of the invention. As previously noted, determining the target model parameters (ω, θ, α) does not require classifying the target domain dataset. Explanations for aspects of the algorithm are included in double angle brackets in FIG. 4. As indicated, Xt is a set of values that includes normalized gradient magnitude. The normalized gradient magnitude is given by:

$$\frac{{‖ {∇}_{θ} ‖}_{2}}{\sqrt{\vert θ \vert}} \qquad [ EQ . 4 ]$$

In EQ. 4, the ∥ ∥₂ indicates an L2 (or Euclidean) norm, and ∇ indicates a gradient, which is a vector of partial derivatives. The function J(Ø) is a loss function of the reinforcement learning model parameterized by Ø. As indicated, to determine αₜ and θₜ after ωₜ has been obtained, every loss term Lₜ^{m} in the set S={SD, ST} obtained at block 130 (i.e., discriminability losses S_{D} and transferability losses S_{T}) is used. Thus, the index m is from 1 to (NS_{D+}NS_{T}). Convergence (of Ø in the inner loop and of lossₜ in the outer loop) is determined according to known approaches. Essentially, convergence is determined when the relevant value of losses (e.g., J and lossₜ) no longer changes from one iteration to the next. Stated differently, each subsequent iteration is not deemed to further refine the parameters.

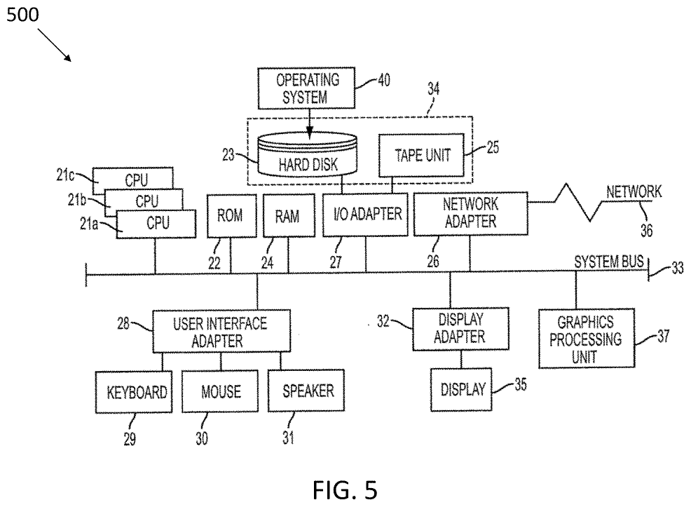

It is understood that one or more embodiments of the present invention are capable of being implemented in conjunction with any other type of computing environment now known or later developed. For example, FIG. 5 depicts a block diagram of a processing system 500 for implementing the techniques described herein (e.g., processes of the method 100). In the embodiment shown in FIG. 5, processing system 500 has one or more central processing units (processors) 21a, 21b, 21c, etc. (collectively or generically referred to as processor(s) 21 and/or as processing device(s)). According to one or more embodiments of the present invention, each processor 21 can include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and can include a basic input/output system (BIOS), which controls certain basic functions of processing system 500.

Further illustrated are an input/output (I/O) adapter 27 and a communications adapter 26 coupled to system bus 33. I/O adapter 27 can be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 300 can be stored in mass storage 34. The RAM 22, ROM 24, and mass storage 34 are examples of memory 19 of the processing system 300. A network adapter 26 interconnects system bus 33 with an outside network 36 enabling the processing system 500 to communicate with other such systems.

A display (e.g., a display monitor) 35 is connected to system bus 33 by display adaptor 32, which can include a graphics adapter to improve the performance of graphics intensive applications and a video controller. According to one or more embodiments of the present invention, adapters 26, 27, and/or 32 can be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 can be interconnected to system bus 33 via user interface adapter 28, which can include, for example, a Super I/O chip integrating multiple device adapters into a single integrated circuit.

According to one or more embodiments of the present invention, processing system 500 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing and has a highly parallel structure that makes it more effective than general-purpose CPUs for algorithms where processing of large blocks of data is done in parallel.

Thus, as configured herein, processing system 500 includes processing capability in the form of processors 21, storage capability including system memory (e.g., RAM 24), and mass storage 34, input means such as keyboard 29 and mouse 30, and output capability including speaker 31 and display 35. According to one or more embodiments of the present invention, a portion of system memory (e.g., RAM 24) and mass storage 34 collectively store an operating system such as the AIX® operating system from IBM Corporation to coordinate the functions of the various components shown in processing system 500.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
obtaining, using a processor system, a source domain dataset, wherein the source domain dataset includes corresponding labels, and the source domain dataset and the corresponding labels are associated with training a source domain machine learning model;
obtaining, using the processor system, a target domain dataset without corresponding labels;
obtaining, using the processor system, a feature vector that identifies features in the source domain dataset and the target domain dataset without an indication of domain;
obtaining a set of loss terms from known machine learning models that implement a domain adversarial neural network (DANN) architecture, wherein the DANN architecture includes feed-forward propagation and backpropagation and a formulation of the DANN architecture includes a minimum portion and a maximum portion; and
obtaining a target domain machine learning model based on the source domain dataset, the target domain dataset, the feature vector, and the set of loss terms and without determining corresponding labels for the target domain dataset in order to perform training.

2. The computer-implemented method according to claim 1, wherein obtaining the feature vector includes initializing a model with the DANN architecture.

3. The computer-implemented method according to claim 2, wherein obtaining the target domain machine learning model includes determining parameters for the model with the DANN architecture.

4. The computer-implemented method according to claim 1, wherein obtaining the set of loss terms S includes obtaining discriminability loss terms S_{D} and transferability loss terms S_{T} to obtain S={S_{D}, S_{T}}.

5. The computer-implemented method according to claim 4, wherein obtaining the discriminability loss terms S_{D} includes obtaining, from the known machine learning models, loss terms of the minimum portion.

6. The computer-implemented method according to claim 4, wherein obtaining the transferability loss terms S_{T} includes obtaining, from the known machine learning models, loss terms of the maximum portion.

7. The computer-implemented method according to claim 1, wherein obtaining the target domain machine learning model includes using reinforcement learning.

8. A system comprising:
a memory having computer readable instructions; and
one or more processors for executing the computer readable instructions, the computer readable instructions controlling the one or more processors to perform operations comprising:
obtaining a source domain dataset, wherein the source domain dataset includes corresponding labels, and the source domain dataset and the corresponding labels are associated with training a source domain machine learning model;
obtaining a target domain dataset without corresponding labels;
obtaining a feature vector that identifies features in the source domain dataset and the target domain dataset without an indication of domain;
obtaining a set of loss terms from known machine learning models that implement a domain adversarial neural network (DANN) architecture, wherein the DANN architecture includes feed-forward propagation and backpropagation and a formulation of the DANN architecture includes a minimum portion and a maximum portion; and
obtaining a target domain machine learning model based on the source domain dataset, the target domain dataset, the feature vector, and the set of loss terms and without determining corresponding labels for the target domain dataset in order to perform training.

9. The system according to claim 8, wherein obtaining the feature vector includes initializing a model with the DANN architecture.

10. The system according to claim 9, wherein obtaining the target domain machine learning model includes determining parameters for the model with the DANN architecture.

11. The system according to claim 8, wherein obtaining the set of loss terms S includes obtaining discriminability loss terms S_{D} and transferability loss terms S_{T} to obtain S={S_{D}, S_{T}}.

12. The system according to claim 11, wherein obtaining the discriminability loss terms S_{D} includes obtaining, from the known machine learning models, loss terms of the minimum portion.

13. The system according to claim 11, wherein obtaining the transferability loss terms S_{T} includes obtaining, from the known machine learning models, loss terms of the maximum portion.

14. The system according to claim 8, wherein obtaining the target domain machine learning model includes using reinforcement learning.

15. A computer program product comprising a computer readable storage medium having program instructions embodied therewith, the program instructions executable by a processor to cause the processor to perform operations comprising:
obtaining a source domain dataset, wherein the source domain dataset includes corresponding labels, and the source domain dataset and the corresponding labels are associated with training a source domain machine learning model;
obtaining a target domain dataset without corresponding labels;
obtaining a feature vector that identifies features in the source domain dataset and the target domain dataset without an indication of domain;
obtaining a set of loss terms from known machine learning models that implement a domain adversarial neural network (DANN) architecture, wherein the DANN architecture includes feed-forward propagation and backpropagation and a formulation of the DANN architecture includes a minimum portion and a maximum portion; and
obtaining a target domain machine learning model based on the source domain dataset, the target domain dataset, the feature vector, and the set of loss terms and without determining corresponding labels for the target domain dataset in order to perform training.

16. The computer program product according to claim 15, wherein obtaining the feature vector includes initializing a model with the DANN architecture.

17. The computer program product according to claim 16, wherein obtaining the target domain machine learning model includes determining parameters for the model with the DANN architecture.

18. The computer program product according to claim 15, wherein obtaining the set of loss terms S includes obtaining discriminability loss terms S_{D} and transferability loss terms S_{T} to obtain S={S_{D}, S_{T}}.

19. The computer program product according to claim 18, wherein obtaining the discriminability loss terms S_{D} includes obtaining, from the known machine learning models, loss terms of the minimum portion and obtaining the transferability loss terms S_{T} includes obtaining, from the known machine learning models, loss terms of the maximum portion.

20. The computer program product according to claim 15, wherein obtaining the target domain machine learning model includes using reinforcement learning.
